(19) United States
(12) Patent Application Publication
(10) Pub. No.: US 2018/0128156 A1
(43) Pub. Date: May 10, 2018

(54) ARRANGEMENT OF A GENSET AND A CONTAINER

(71) Applicant: GE Jenbacher GMBH & CO OG, Jenbach (AT)

(72) Inventors: Peter WATSON, Garching dei Munchen (GB); Clement LEROUX, Jenbach (AT)

(21) Appl. No.: 15/571,980

(22) PCT Filed: Mar. 31, 2016
(86) PCT No.: PCT/AT2016/050086

§ 371 Date: Nov. 6, 2017

(30) Foreign Application Priority Data
May 5, 2015 (AT) A 271/2015

(51) Int. Cl. F01P 11/10; F02B 63/04; F01P 11/12; F01P 5/04

(52) U.S. Cl. CPC F01P 11/10; F02B 63/044; F01P 11/12; F01P 2070/52; F01P 2050/08; F01P 2070/50; F01P 5/04

(57) ABSTRACT

An arrangement of a genset and a container, in which the genset is arranged, whereby the arrangement also comprises a cooling device and the genset can be cooled in the operating state of the genset by the cooling device, whereby the cooling device is arranged between a first position in which the cooling device is arranged entirely within the container, and a second position in which at least part of the cooling device can be moved at least partially outside the container, whereby the genset can be moved into its operating state when the cooling device is in the second position.

### BACKGROUND OF THE INVENTION

The invention relates to an arrangement comprising a genset and a container with the features of the preamble of claim 1.

### BRIEF DESCRIPTION OF THE INVENTION

Gensets (an abbreviated form of “generator sets”) refer to internal combustion engines coupled to a generator. Gensets are often used for the decentralized provision of electrical power.

Containers are used for the safe transport of the genset, wherein, in certain applications, the genset also remains in the container during operation. This is particularly relevant to applications where the genset is only temporarily left at an installation site.

An arrangement of a container and a genset is shown, for example, in US 2003 0029390 (General Electric). US 2003 0029390 is intended for the prevention of undesirable leakage of operating fluids.

The dimensions of containers are defined in ISO standard 668. For example, a 20-foot container has the internal dimensions (length×width×height) of 5.898 m×2.352 m×2.385 m. It is very important that all components required for the operation of the genset can be accommodated in a single container. Dividing the cargo into several containers increases the logistical effort and transport costs. Of course, the smallest possible container is always selected. As a result, the genset is packed extremely tightly in a container with all the components required for operation.

The problem here is that, due to the tight packing of the components required for operation, the free flow cross-sections and/or a sufficient distance to the next object arranged in the flow path are very restricted for effective ventilation of the genset. The reductions in cooling lead to the fact that gensets operated in containers often cannot be operated at their maximum power, i.e. they are operated at lower power levels, i.e. “derated”. Another undesirable option is to set up a separate cooling unit at the plant, which increases the costs and logistical effort.

For the operator of the genset, however, the power available from the genset is decisive. A reduced power of the genset means higher costs per kilowatt of generated electrical power.

The object of the invention is to provide an arrangement comprising a genset and a container, by means of which the disadvantages from the prior art are avoided. An embodiment of the invention provides an arrangement of a genset and a container comprising a cooling device and the genset that can be cooled in the operating state of the genset by the cooling device. The cooling device can be moved between: a first position wherein the cooling device is arranged entirely within the container; and a second position wherein at least part of the cooling device is at least partially outside the container, wherein the genset can be moved into its operating state when the cooling device is in the second position.

An embodiment of the cooling device can be moved between a first position in which the cooling device is arranged entirely within the container and a second position in which at least part of the cooling device is at least partially outside the container, wherein the genset is able to be moved into its operating state when the cooling device is in the second position, the cooling situation of the genset in the container can be improved substantially.

In other words, an embodiment of the invention provides that, in a first position (the transport position), all components necessary for the operation of the genset are accommodated within the container, and that, in a second position (for the operation of the genset), at least a part of the cooling device is moved out of the container. The second position is, of course, not intended to be a broken-down state or a disassembly of the arrangement of the genset and the cooling device, but rather a state in which the genset can be operated.

It may be provided that the arrangement has a drive device for moving the cooling device at least partially between the first and second positions. Owing to the large mass of a cooling device, it may be helpful to provide a drive device for moving the cooling device between the positions. This can be designed, for example, simply as a mechanical lever mechanism so that the cooling device can be moved manually. Alternatively, electrical or pneumatic drives can of course be used.

It may be provided that the cooling device comprises a mounting device on which the cooling device is mounted. It has proved to be useful to provide a mounting device on which the cooling device rests and, if necessary, can be moved on or with this mounting device.

In general, the cooling device comprises a radiator and/or at least one fan. There are also designs that incorporate radiators and fans.

More particularly, provision can be made for the container to have at least one rail, on which the cooling device, in an embodiment on the mounting device, can be moved between the first and second positions. The presence of a rail facilitates the movement of the cooling device and increases the safety of the operation.

Conveniently, it is provided that, in the container along a direction that connects the first and the second position, fastening devices spaced apart from one another are provided, by means of which the cooling device can be fastened relative to the container in the first or second position or between the first and second positions. To be able to withstand loads in operation and to guarantee a secure positioning, it is useful to anchor the cooling device in its respective positions. This can be done, for example, with clamps or bolts.

Provision can be made for the cooling device is mounted on rollers, by means of which the cooling device can be moved between the first and second positions. This allows the cooling device to be moved with particular ease. For example, the cooling device can be movably mounted on rails via the mounting device via rollers.

The cooling device may rest on or be mounted on a frame of the genset. Generally, gensets in containers are not located directly on the container floor, but have their own frame. The cooling device can therefore also be mounted on this frame. Alternatively, the cooling device has a separate frame.

It may be provided that the mounting device has an extension for holding the radiator or fan in the second position, whereby the extension can be attached to the mounting device. In the simplest form, the extension may be a rail or beam section on which the radiator and/or fan are then mounted in the second position.

It can also be provided that the mounting device has a pull-out part that can be pulled out from a base element of the mounting device in order to hold the radiator or fan in the second position of the cooling device. According to this variant, therefore, the radiator and/or fan are mounted on a pull-out part similar to an extension of a drawer.

It is provided, in an embodiment, that the mounting device has openings which allow the insertion of a fork of a forklift truck. It may be practical to bring the cooling device or parts thereof into the respective position by means of a forklift truck.

It may be provided that the container has at least one opening which can be closed when the cooling device is in its first position and/or opened when the cooling device is in its second position. In general, containers have a large front door that is closed during transport. For operation, this door can be opened, and also to remove parts of the cooling device.

Provision can be made for a control cabinet of the genset to be supported in the container via a further mounting device, and the further mounting device can be moved between a first position in which the control cabinet is entirely inside the container and a second position in which the control cabinet is at least partially outside the container.

### BRIEF DESCRIPTION OF THE DRAWINGS

The invention is explained in more detail with reference to the figures. The figures show the following:

FIG. 1 a schematic arrangement of a genset in a container in the cross-section,

FIG. 2 cooling device and container in the transport position,

FIG. 3 a perspective view of a cooling device in the transport position,

FIG. 4 cooling device and container in the operating position,

FIG. 5 cooling device in the operating position,

FIG. 6A, 6B schematic representation of the arrangement of the cooling device and the genset in the transport or operating positions in one exemplary embodiment,

FIG. 7A, 7B schematic representation of a cooling device and a genset in the transport or operating positions according to another exemplary embodiment, and

FIG. 8 Details of the mounting device.

### DETAILED DESCRIPTION

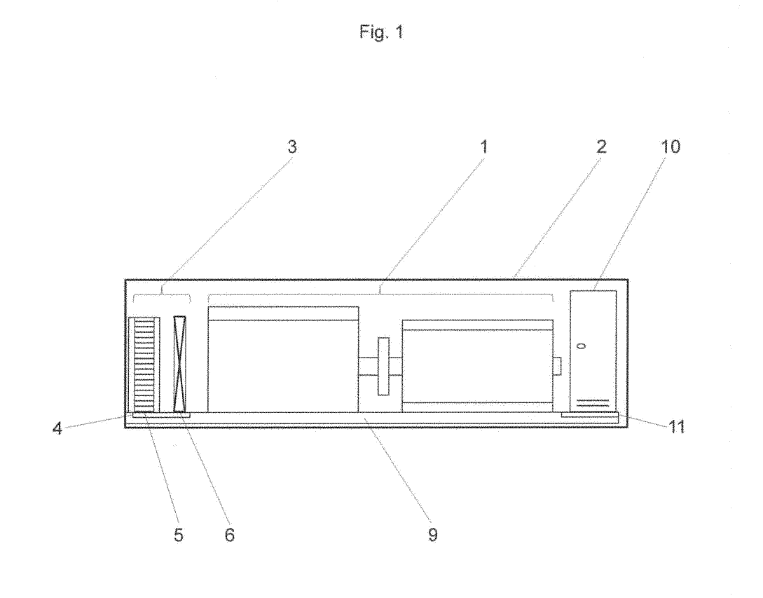

FIG. 1 shows a schematic representation of an arrangement of a genset 1 and a cooling device 3 in a container 2. The genset 1 consists of an internal combustion engine, which is mechanically connected to a generator via a coupling. The internal combustion engine (left within genset 1) and the generator (right within genset 1) are only shown by implication. The cooling device 3 consists of a radiator 5 and a fan 6 and rests on a mounting device 4. The internal combustion engine is cooled by a flow of coolant that passes through the radiator 5. The cooling air is moved by the fan 6 through the radiator 5. In the exemplary embodiment shown, the mounting device 4 is arranged on the frame 9 carrying the genset 1. It can, of course, also be arranged on a separate frame. A control cabinet 10, which rests on a mounting device 11, is also housed in the container 2.

Fastening devices 15 can be provided, by means of which the cooling device 3 can be fixed in a first or second position or between them in relation to the container 2.

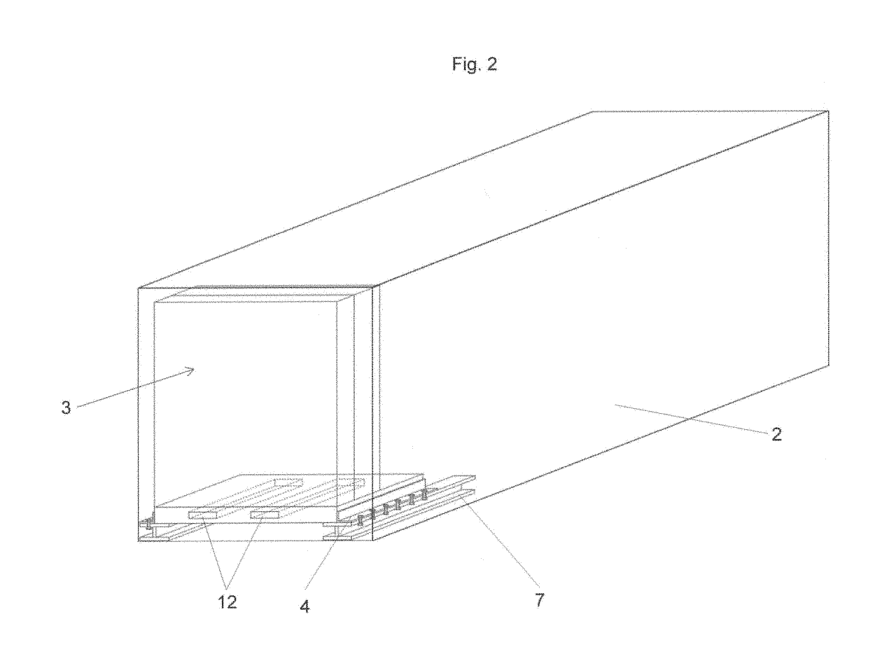

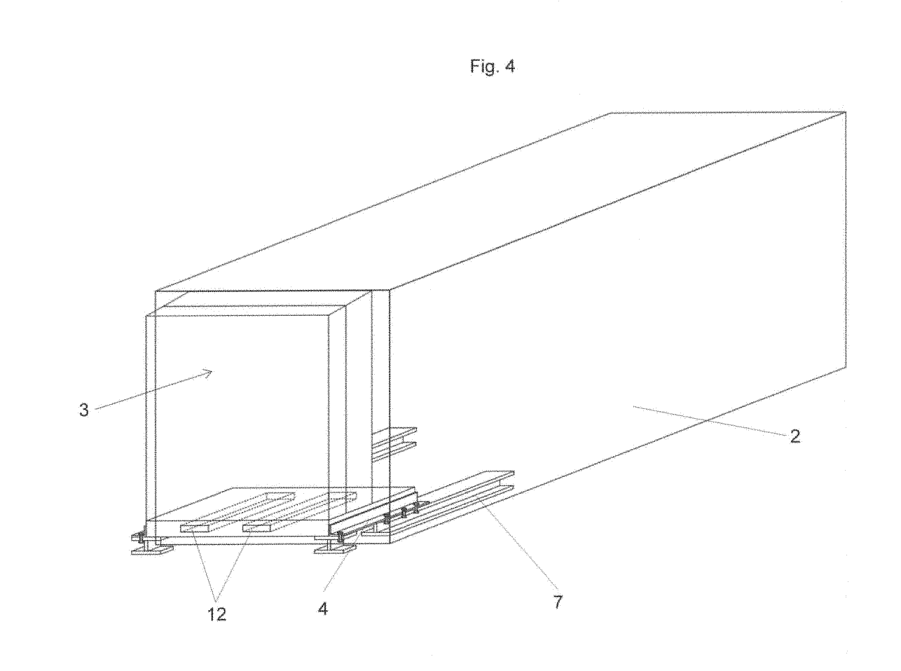

FIG. 2 shows a perspective representation of a container 2 in which a cooling device 3 is movably mounted on a rail 7 by means of a mounting device 4. The cooling device 3 can thus be moved along the rail 7 from the transport position (“first position”) shown here to an operating position (“second position”) shown in FIG. 4. This can be done, for example, with the aid of a forklift truck. For this purpose, mounting openings 12 are provided, into which the forks of a forklift truck can be inserted. In the transport position of the cooling device 3 shown here, this is located entirely inside the container 2.

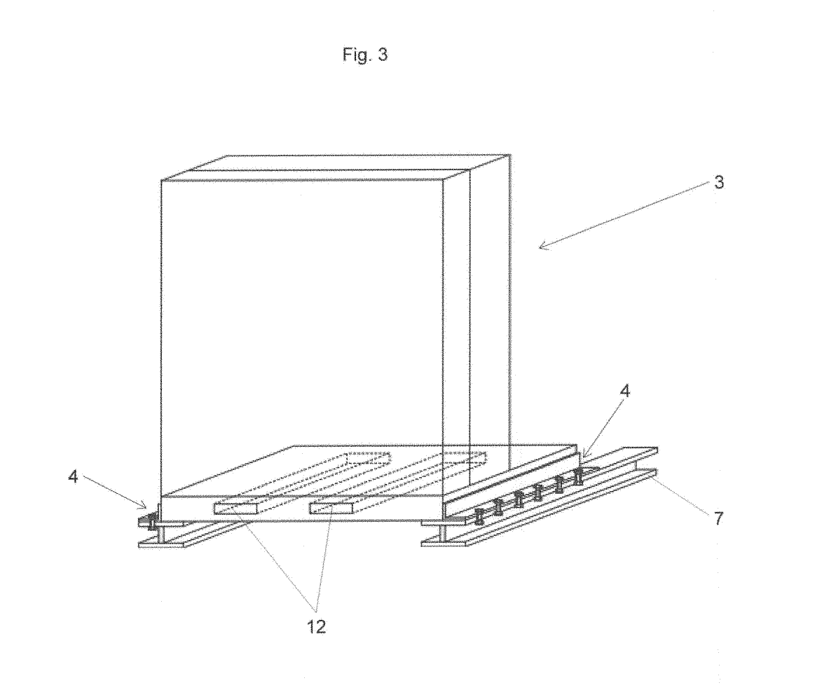

FIG. 3 shows the situation of FIG. 2 in detail. It shows a cooling device 3 mounted on a frame 9 by means of fastening elements via a mounting device 4. For the sake of clarity, the other components such as the container and genset are not shown in the figure. A structural detail of an embodiment of the invention is therefore shown. The transport position of the cooling device 3 in the container 2, i.e. the position which allows a particularly narrow packing of the components involved: the cooling device 3, genset 1 and container 2, is shown in the figure. In addition, mounting openings 12 are shown in which, for example, the forks of a forklift truck can be inserted. The mounting device 4 can thus be moved relative to the frame 9.

FIG. 4 shows the operating position (“second position”) of the cooling device 3 in a perspective representation analogous to FIG. 2. The cooling device 3 is here moved out of the container 2 along the rail 7. Therefore, shown here is the position of the cooling device 3, in which the genset 1 (not shown in the representation) is located in the container 2.

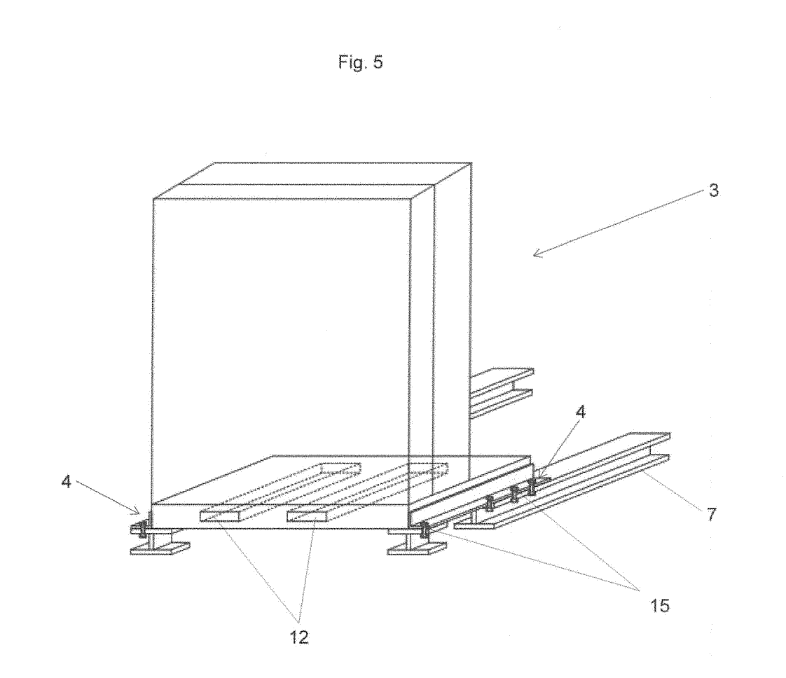

FIG. 5 shows the situation according to FIG. 4 in an enlarged representation. It can be seen that the cooling device 3 is displaced along the rail 7 by means of the mounting device 4 in its longitudinal axis opposite to the analogous representation in FIG. 3 in the direction of the observer.

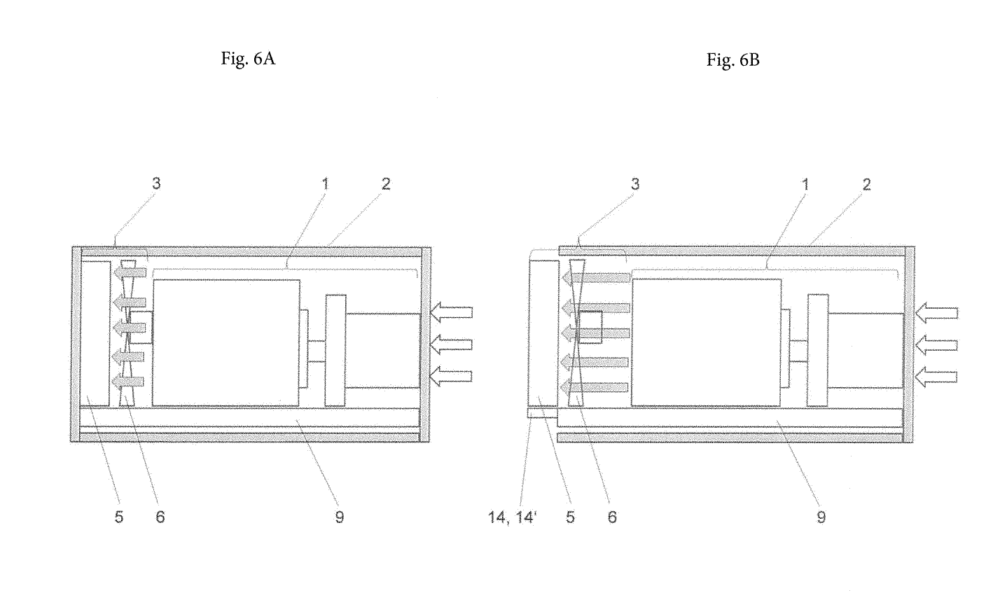

FIGS. 6A and 6B schematically show cross-sections of a container 2, in which a cooling device 3 and a genset 1 are arranged. FIG. 6A shows the transport position, while FIG. 6B shows the operating position. In the transport position according to FIG. 6A, all components are located entirely within the envelope of the container 2. In the operating position according to FIG. 6B, the cooling device 3 is moved outward.

Optionally, the cooling device 3 can be moved outwards by means of an extension 14 or a pull-out part 14′.

In the present embodiment, fresh air enters the container 2 through the side opposite the radiator 5 as indicated by the non-shaded arrows. This arrangement is advantageous in relation to a cooling effect on the generator, but the air temperature increases with the movement through the container 2, such that the cooling capacity of the cooler 5 is reduced.

The air flow is indicated by gray arrows. It can be seen that, in the operating position according to FIG. 6B, substantially more favorable flow conditions prevail at the cooling device 3 than in the transport position according to FIG. 6A.

In the exemplary embodiment shown, the radiator 5 and the fan 6 of the cooling device 3 can be displaced horizontally outward, such that, in the operating position, the cooling device 3 is partly outside the envelope of the container 2.

Depending on the fastening situation of the radiator 5, however, there are certainly also other possibilities for moving the cooling device 3 outward, for example by rotation or a vertical movement. This can also be used for parts of the arrangement, for example in order to move the fan 6 above the container envelope.

At least on the container side adjacent to the cooling device 3, a gate can be provided. In the operating state, such a gate can be opened or removed.

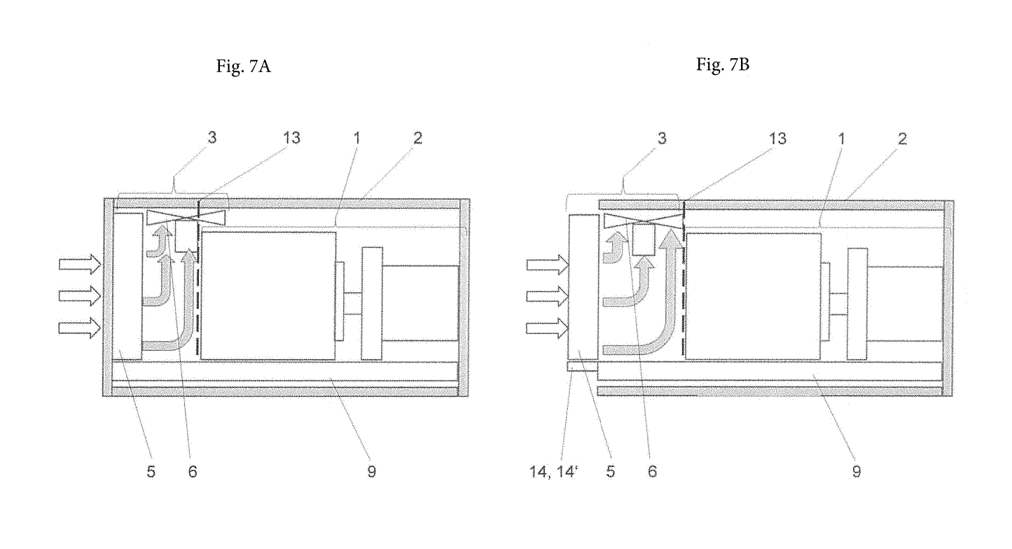

FIGS. 7A and 7B show schematic cross-sections of an arrangement according to an alternative exemplary embodiment.

FIG. 7A again shows the transport position, while FIG. 7B shows the operating position. In the variant shown in FIGS. 7A and 7B, the fan 6 of the cooling device 3 is arranged vertically, i.e. the outflow of the cooling air is upward through the roof of the container 2.

In the transport position according to FIG. 7A, the cooling device 3 is located entirely within the envelope of the container 2. In the operating position according to FIG. 7B, the cooling device 3 is located partly outside the envelope of the container 2. The arrows symbolize the flow direction of the cooling air.

In the exemplary embodiment shown, the fresh air flows into the container 2 through the side near the radiator, as indicated by the non-shaded arrows.

In the exemplary embodiment shown, there would be only insufficient incoming flow of the fan 6 in the transport position. In other words, the radiator 5, the fan 6 and the genset 1 are arranged so compactly in the transport position that a complete cooling function would not exist because of the restriction of the free flow cross-sections. In the operating position according to FIG. 7b, on the other hand, the radiator 5 and fan 6 are positioned such that a complete incoming flow of the fan 6 or a sufficient distance to the next object arranged in the flow path is ensured.

In the container 2, a partition wall 13 can be provided, which separates the cooling device 3 from the genset 1. The partition wall 13 can direct the flow of the cooling air and contribute to better cooling performance of the radiator 5. At least on the container side adjacent to the cooling device 3, a gate can be provided. In the operating state, such a gate can be opened or removed.

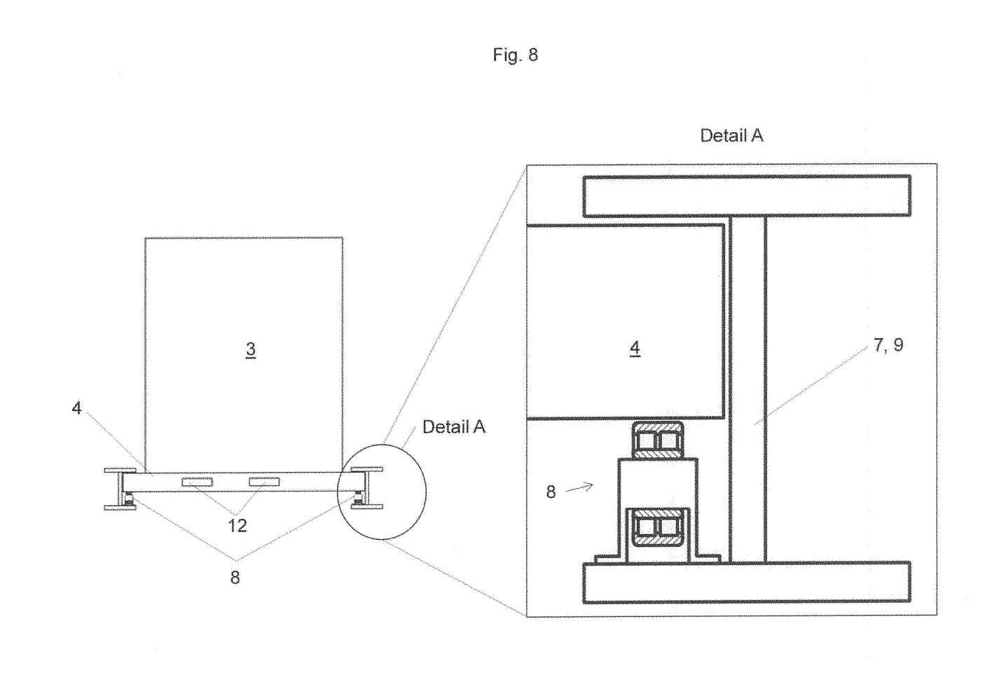

FIG. 8 shows structural details, as can be implemented, for example, on a mounting device 4. In the example shown, the mounting device 4 is movably mounted on a rail 7 or rails 7 via rollers 8. The rail(s) 7 can be formed by the frame 9 or as a separate component. Thus, the mounting device 4 carrying the cooling device 3 can be moved with particular ease. For movement with a forklift truck, mounting openings 12 are provided, into which the forks of a forklift truck can be inserted. Alternatively, for example, the rollers 8 could be designed as a drive device that can be operated electrically, pneumatically or manually.

The invention is explained in reference to a genset, but can also be used in the same way for a mechanically driven unit.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An arrangement of a genset and a container, wherein the genset is arranged, wherein the arrangement also comprises a cooling device and the genset can be cooled in the operating state of the genset by the cooling device, wherein the cooling device can be moved between:
a first position wherein the cooling device is arranged entirely within the container;
and a second position wherein at least part of the cooling device is at least partially outside the container, wherein the genset can be moved into its operating state when the cooling device is in the second position.

2. An arrangement according to claim 1, wherein the arrangement has a drive device configured to move the cooling device at least partially between the first and second positions.

3. An arrangement according to claim 1, wherein the cooling device comprises a mounting device on which the cooling device is mounted.

4. An arrangement according to claim 1, wherein the cooling device comprises a radiator and/or at least one fan.

5. An arrangement according to claim 1, wherein at least one rail is provided in the container, on which the cooling device, on the mounting device, can be moved between the first and second positions.

6. An arrangement according to claim 1, wherein in the container, along a direction that connects the first and the second position, fastening devices spaced apart from one another are provided, by means of which the cooling device can be fastened relative to the container in the first or second position or between the first and second positions.

7. An arrangement according to claim 1, wherein the cooling device is mounted on rollers, by means of which the cooling device can be moved between the first and the second positions.

8. An arrangement according to claim 1, wherein the cooling device rests on or is mounted on a frame of the genset.

9. An arrangement according to claim 1, wherein the mounting device has an extension configured to hold the radiator or fan in the second position, wherein the extension can be attached to the mounting device.

10. An arrangement according to claim 1, wherein the mounting device has a pull-out part that can be pulled out from a base element of the mounting device in order to hold the radiator or fan in the second position of the cooling device.

11. An arrangement according to claim 1, wherein the mounting device has openings that allow the insertion of a fork of a forklift truck.

12. An arrangement according to claim 1, wherein the container has at least one opening which can be closed when the cooling device is in its first position and/or opened when the cooling device is in its second position.

13. An arrangement according to claim 1, wherein a control cabinet of the genset is supported in the container via a further mounting device, and wherein the further mounting device can be moved between a first position wherein the control cabinet is entirely inside the container and a second position wherein the control cabinet is at least partially outside the container.
